(19) United States
(12) Patent Application Publication
(10) Pub. No.: US 2012/0092948 A1
(43) Pub. Date: Apr. 19, 2012

(54) Concrete vibrator system and motor therefor

(75) Inventors: Glenn Heimbruch, Franklin, WI (US); Paul Jaworski, Shorewood, IL (US)

(73) Assignee: Racine Federated, Inc..

(21) Appl. No.: 12/322,187

(22) Filed: Jan. 30, 2009

(51) Int. Cl. B01F 11/00; H02P 25/14; G05B 19/042; H02K 9/06

(52) U.S. Cl. 366/128; 310/62; 318/245; 318/163

(57) ABSTRACT

A concrete vibrator system with a constant speed motor, one of a set of vibrator heads with different load characteristics, and one of a set of drive shafts connecting the motor output shaft with one of the vibrator heads. A speed control circuit senses motor shaft speed and maintains constant speed. The motor is cooled by a fan mounted on the motor rotor which draws air through an inlet and exhausts air through an outlet both of which face downwardly when the motor is in use. Rain or other liquids are prevented from reaching the motor.

### BACKGROUND OF THE INVENTION

It is common practice to consolidate concrete by vibrating the concrete before it sets, particularly to release entrapped air and to encourage lower slump concrete to flow into corners, filling forms, and to make intimate contact with support structures, as reinforcing bars. A tool for consolidating pours of low slump (0″-2″) through medium slump (2″-6″) concrete consistencies as in building footings, thin slabs, narrow walls, etc., comprises a manually manipulated vibrating head connected by a flexible shaft with a portable electric motor. Such a tool is illustrated in Wyzenbeek U.S. Pat. No. 3,042,386. A flexible drive shaft is shown in Wyzenbeek U.S. Pat. No. 3,180,625. The load on the motor and thus the motor speed depends on the head size, shaft size and length, and whether or not the head is immersed in concrete. Where a range of head sizes and cable sizes and lengths are provided to accommodate different concrete conditions, a plurality of motors may be required to provide acceptable vibration speeds. Moreover, the vibration speed achieved varies substantially depending on the system components and the concrete characteristics.

A motor used in a vibrator system typically has a fan which moves cooling air across the motor. See Holther, Jr. U.S. Pat. No. 3,894,254. However, the air inlet and outlet are unprotected, and the motor is subject to damage from rain and other liquids to which the motor is exposed during use.

### BRIEF SUMMARY OF THE INVENTION

One feature of the invention is a concrete vibrator system with a constant speed motor having an output shaft, one of a set of drive shafts with different load characteristics connected with and driven by the motor output shaft, and one of the set of vibrator heads with different load characteristics connected with and driven by the one drive shaft at a commanded optimum speed, e.g., 10,500 vibrations per minute (VPM), for any drive shaft and any vibrator head. With this system, only one motor is needed for any combination of drive shaft and vibrator head and the optimum vibrator speed is provided with any drive shaft and vibrator head.

Another feature of the invention is a concrete vibrator with an A-C motor operating from an A-C source and a closed loop feedback phase angle control circuit responsive to rotation of the motor shaft to maintain a constant shaft speed.

A further feature of the invention is a motor having a stator and rotor with a fan connected with the rotor for moving cooling air across the stator and rotor, and a base on which the motor rests, with an inlet through which the fan draws cooling air, the inlet opening toward the base and an outlet through which the fan exhausts cooling air, the outlet opening toward the base whereby when the motor rests on the base the inlet and outlet open downwardly.

Further features and advantages of the invention will appear from the following specification and from the drawings.

### BRIEF DESCRIPTION OF THE SEVERAL VIEWS OF THE DRAWINGS

FIG. 1 is a diagram of the motor, shaft set, and vibrator head set;

FIG. 2 is a schematic of the motor speed control circuit;

FIG. 3 is a processor logic diagram for constant speed control;

FIG. 4 is a processor logic diagram for ramp speed control and operator speed selection;

FIG. 5 is a perspective view of the motor;

FIG. 6 is a longitudinal section through the motor along line 6-6 of FIG. 5;

FIG. 7 is a transverse section through the air inlet along line 7-7 of FIG. 5; and

FIG. 8 is a transverse section through the air outlet along line 8-8 of FIG. 5.

### DETAILED DESCRIPTION OF THE INVENTION

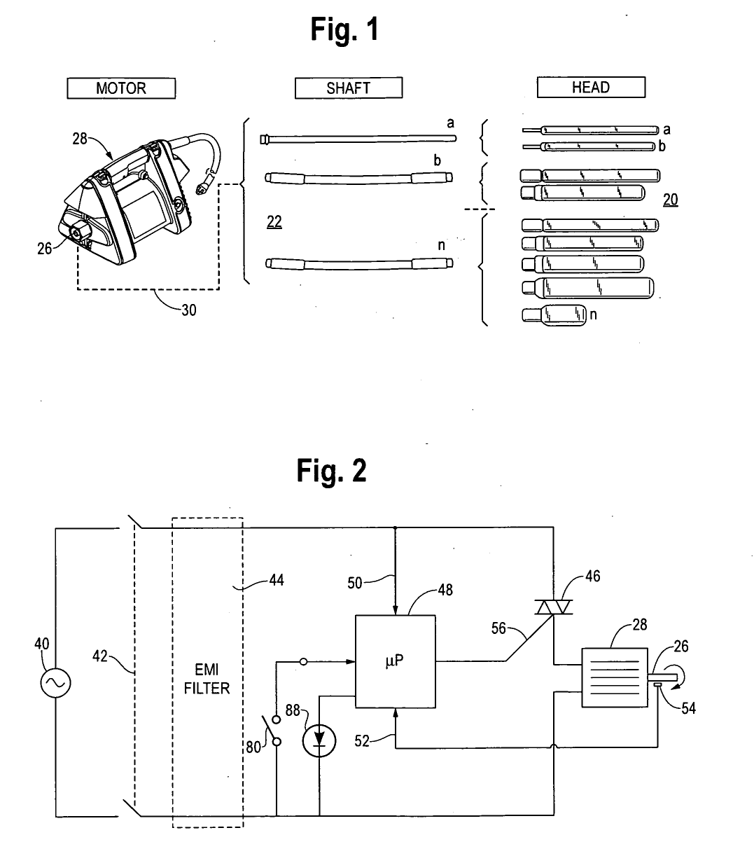

The components of a concrete vibrator system are shown diagrammatically in FIG. 1. One of a set a-n different vibrator heads 20 is connected through a selected one of a set a-n of different drive shafts 22 as indicated by dashed line 24. The one drive shaft is connected with and driven by the rotor shaft 26 of a constant speed motor 28 as indicated by dashed line 30. The diameter and length of the vibrator head are selected with regard to the dimensions of the concrete structure being formed and the location and size of reinforcing, e.g., bars or mesh, so that the vibration may be accomplished without damage to the reinforcing by contact of the vibrating head. The diameter of the drive shaft is selected to match the selected vibrator head, and the shaft length, e.g., two-twenty feet, is selected for the operator to efficiently manipulate the vibrator head as required to consolidate the poured concrete.

Constant speed motor 28 is an electric motor, preferably a universal motor, operated from an A-C source through a motor speed control circuit, FIG. 2. The control circuit is connected with A-C source 40, 115/230 volts A-C, 50 or 60 Hz., through power switch 42 and an electromagnetic interference (EMI) filter 44. The motor speed control circuit controls the time of firing triac 46 in relation to the zero crossing of the source voltage. A shift in the time of firing produces a change of the voltage to the motor 28 and thus motor speed.

The control circuit includes a programmed processor 48 which has a voltage phase input 50 and a motor shaft speed input 52 from Hall effect sensor 54 which senses rotation of motor shaft 26. The processor provides trigger input 56 to triac 46 combining phase angle control with closed loop feedback of motor speed and the motor 28 runs at an optimum commanded speed with any combination of vibrator head 20 and flexible shaft 22, whether loaded or unloaded; and minimizes power consumption as the triac 46 conducts during only a portion of each cycle.

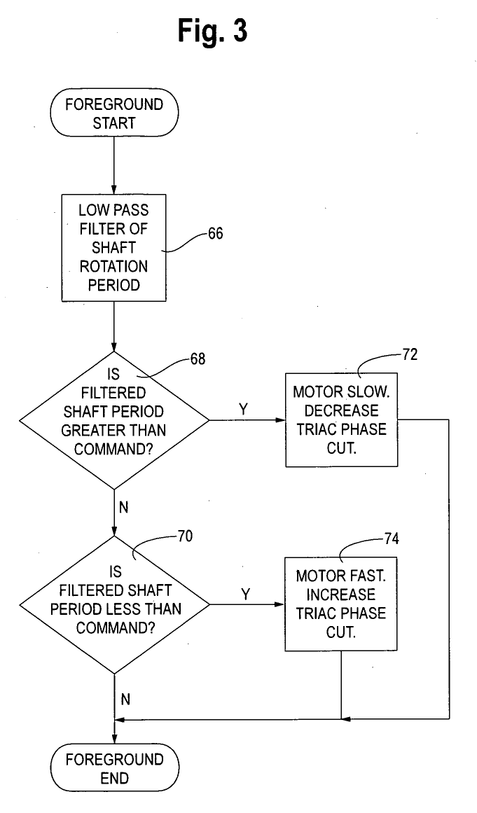

The logic diagram, FIG. 3, for processor 48 provides constant motor speed. At block 66, the feedback signal representing shaft rotation period derived from sensor 54 is low-pass filtered at block 66. Blocks 68 and 70 determine whether the shaft rotation period is correct. If the shaft rotation period is greater than commanded at block 68, the motor is slow and the triac phase cut is decreased at block 72. If the shaft period is less than commanded at block 70, the motor is running too fast and the triac phase cut is increased at block 74.

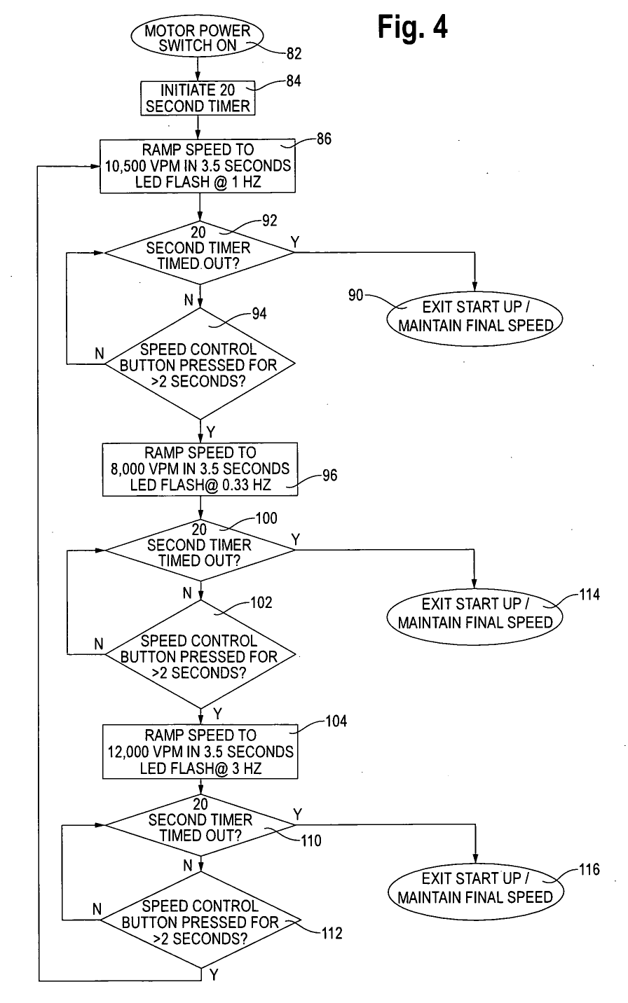

It is desirable to start the motor slowly and ramp the speed up to the commanded speed over a short period of acceleration. Additionally, the motor control may provide for operator selection of the motor speed. The logic diagram of FIG. 4 and an operator speed selection switch 80, FIG. 2, connected with processor 48 provide for these features. To start the motor, power switch 42, FIG. 2, is closed, block 82. This initiates a 20 second timer, block 84, and a voltage ramp block 86 to bring the vibrator speed to 10,500 VPM. A speed indicator, LED 88, FIG. 2, flashes at 1 Hz. In the preferred single speed vibrator the control exits startup, maintaining the programed speed, block 90 and FIG. 3.

Where speed selection is provided, the operator selects a different speed by closing switch 80 (pressing a control button) within the twenty second period following start up, blocks 92, 94 and 96. Motor speed is ramped downwardly to 8,000 VPM in 3.5 seconds and the LED 88 flashes at 0.33 Hz. If the speed control button is pressed closing switch 80 a second time before the twenty second timer times out, motor speed is ramped to 12,000 VPM and LED 88 flashes at 3 Hz., blocks 100, 102, and 104. If the speed control button is pressed a third time during the twenty second time period, motor speed returns to 10,500 VPM, blocks 110, 112, and 86. When the twenty second timer times out, the then selected speed is maintained, blocks 90, 114, and 116 and FIG. 3.

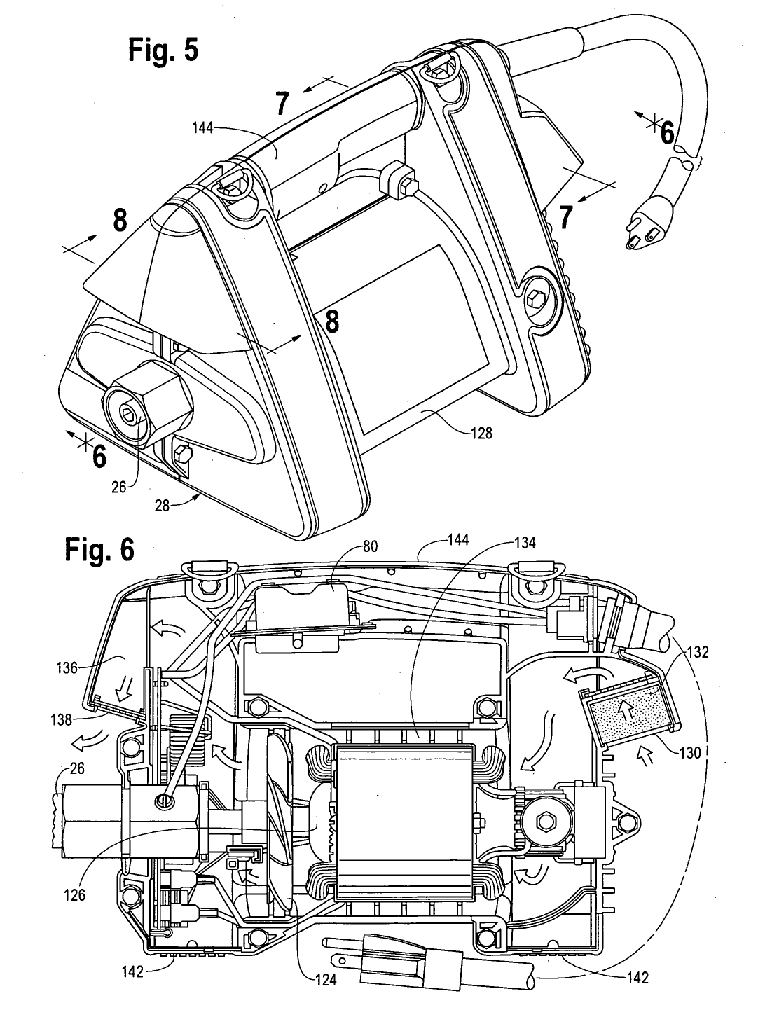

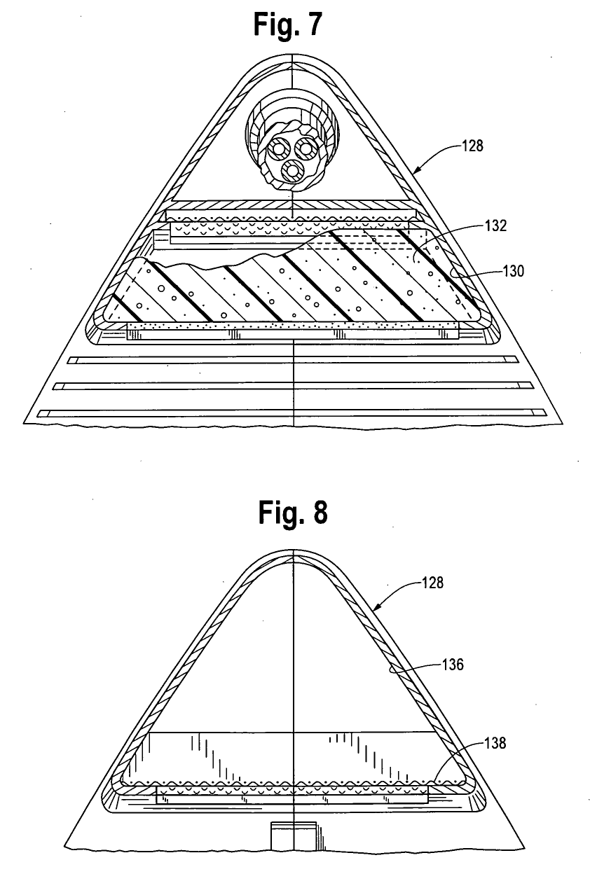

The novel cooling arrangement for the motor is shown in FIGS. 5-8. An axial fan 124 is mounted on the rotor 126 of the motor and draws air into the housing through inlet 130 and filter 132. The air passes over armature 126 and field 134 and is discharged through outlet 136 and screen 138. The motor housing 128 has a base 142 on which the motor may rest during use. The motor also has a handle 144 opposite base 142 by which the operator may carry the motor during use. Speed selection switch 80 is mounted in handle 144. Both air inlet 130 and air outlet 136 open toward the base and are thus open downwardly when the motor rests on the base or is carried by handle 144. Ingress of rain or other liquids to which the motor is exposed is prevented.

1. A concrete vibrator system, comprising:
a constant speed motor having an output shaft;
one of a set of drive shafts with different load characteristics connected to and driven by the motor output shaft; and
one of a set of vibrator heads with different load characteristics connected with and driven by said one drive shaft at a constant speed for any shaft of said set of shafts and any vibrator head of said set of vibrator heads.

2. The concrete vibrator system of claim 1 in which said vibrator head is driven at a constant speed whether the vibrator head is in fluid concrete or in air.

3. The concrete vibrator system of claim 1 wherein said constant speed motor comprises an A-C motor operating from an A-C source and a control circuit responsive to rotation of said motor shaft to maintain constant motor shaft speed.

4. The concrete vibrator system of claim 3 wherein the control circuit further comprises a processor responsive to source phase angle and motor shaft rotation in a closed loop feedback phase angle circuit to maintain constant motor shaft speed.

5. The concrete vibrator system of claim 3 wherein the said control circuit further comprises a processor programmed to ramp the motor shaft speed on startup.

6. The concrete vibrator system of claim 3 wherein said control circuit further comprises an operator actuated switch to select motor shaft speed.

7. A concrete vibrator comprising:
A constant speed motor comprising an A-C motor operating from an A-C source and a closed loop feedback phase angle control circuit responsive to rotation of the motor shaft to maintain a constant motor shaft speed;
a drive shaft connected to and driven by the motor shaft; and
a vibrator head driven by said drive shaft at a constant speed.

8. The concrete vibrator of claim 7 wherein said control circuit further comprises a processor programmed to ramp the motor shaft speed on startup.

9. The concrete vibrator of claim 7 wherein said control circuit further comprises an operator-actuated switch connected with said control circuit to select motor shaft speed.

10. (canceled)

11. (canceled)

12. (canceled)

13. (canceled)

14. (canceled)

15. (canceled)

16. (canceled)

17. The method of consolidating reinforced concrete in a form, comprising:
providing a portable electrical motor with a rotating shaft;
providing a set of vibrator heads of different diameters and lengths;
providing a set of drive shafts of diameters to match the motor shaft with the diameters of said vibrator heads and of different lengths;
selecting from said set of vibrator heads a vibrator head of dimensions to match the reinforcement for and the form in which the concrete is to be consolidated;
selecting from said set of drive shafts a drive shaft with a diameter to connect said motor shaft with the shaft of the selected vibrator head and a length with which the selected vibrator head is manually manipulatable in concrete in said form;
connecting the selected vibrator head through the selected drive shaft with the motor shaft;
establishing a commanded motor speed;
comparing the actual motor shaft speed with the commanded motor shaft speed; and
if the actual motor shaft speed differs from the commanded motor shaft speed, modifying the motor shaft speed to the commanded motor shaft speed.

18. The method of claim 17 in which the motor shaft speed is modified by ramping it to the commanded motor shaft speed.

19. The method of claim 17 in which the actual motor shaft speed is sensed by measuring the rotating shaft rotation.

20. The method of claim 17 in which a time period is initiated on starting the motor and during the time period an operator may select the commanded motor shaft speed.
